(19) United States
(12) Patent Application Publication
(10) Pub. No.: US 2017/0011016 A1
(43) Pub. Date: Jan. 12, 2017

(54) AUTOMATED DOCUMENT GENERATION WITH XQML

(71) Applicant: WEALTHCOUNSEL LLC, Fitchburg, WI (US)

(72) Inventors: Stewart E. Shelline, South Jordan, UT (US); William M. Sawyer, Saratoga Springs, UT (US)

(21) Appl. No.: 15/206,915

(22) Filed: Jul. 11, 2016

Related U.S. Application Data
(60) Provisional application No. 62/191,061, filed on Jul. 10, 2015.
(60) Provisional application No. 62/191,064, filed on Jul. 10, 2015.

(51) Int. Cl. G06F 17/22; G06F 17/21

(52) U.S. Cl. CPC G06F 17/2247; G06F 17/218

(57) ABSTRACT

Embodiments are directed to a markup language that allows content and logic statements to be used in the same syntax, as well as generating a markup language document using that markup language. In one scenario, a computer system is provided. The computer system has a processor and a computer readable storage device with instructions that are executable by the processor and that instantiate a user interface that allows a user to provide input including providing a first content statement in a markup language using a specified syntax and providing a first logic statement in the same markup language using the same specified syntax. The computer system also includes a markup language processing engine configured to interpret the first content statement and the first logic statement, and execute the first logic statement within the context of the first content statement.

### CROSS-REFERENCE TO RELATED APPLICATIONS

This application claims priority to and the benefit of U.S. Provisional Patent Application Ser. No. 62/191,061, entitled “XQML Language for Document Drafting,” filed on Jul. 10, 2015, as well as U.S. Provisional Patent Application Ser. No. 62/191,064, entitled “Automated Document Generation with XQML,” filed on Jul. 10, 2015, both of which are incorporated by reference herein in their entirety.

### BACKGROUND

Computing systems have become ubiquitous, ranging from small embedded devices to phones, tablets, PCs and backend servers. Each of these computing systems is designed to process software code. Software allows users to perform functions, interacting with the hardware provided by the computing system. As is well understood, software can be configured to perform a wide variety of functions. Some of these functions include word processing, creating spreadsheets, reading email, playing games, browsing web pages or performing other functions.

In some cases, software is specifically designed to manage and allow interaction with data. For instance, hypertext markup language (HTML) has been extensively used in the web design field for many years. HTML allows web designers to organize text, pictures, videos and other content in a web page. HTML allows web designers to specify titles, headers, body, and other parts of a web page. HTML also allows implementation of different types of software code such as JavaScript or Java applets. HTML5 allows for seamless integration of audio, video, social media feeds, or other data.

This data may be organized using the extensible markup language (XML). XML was designed to allow users to create and encode documents that are both human-readable and machine-readable. XML provides flexibility in allowing users to define their own element tags. Users can then define their own attributes for each element. The elements and attributes may thus be combined to form an XML document. These XML documents can then be displayed on a variety of different applications including word processors, spreadsheets or web pages. The XML documents may also be styled using styles written in the extensible stylesheet language (XSL). The styles may apply to a single document or to a group of XML documents.

When collections of XML documents exist, users may wish to search the XML documents for certain types of content. A query language such as XQuery may be used to search the XML documents. XQuery may further be used to query collections of both structured and unstructured data, including XML documents, text data and data of other formats. XQuery is also a functional programming language that allows extraction and manipulation of data from XML documents or from any data source that can be viewed as XML (such as from a relational database). XQuery can thus perform functions on the XML documents themselves.

In some cases, XML documents may contain links to scripts or other programming functions. In such cases, the syntax for the functional language (i.e. the logic) is different than the syntax for the content. Indeed, creators of XML documents need to draft their document logic using one type of syntax, and draft their document content using another type of syntax. This leads to unnecessary complication when creating XML documents.

### BRIEF SUMMARY

Embodiments described herein are directed to a markup language that allows content and logic statements to be used in the same syntax. Embodiments are further directed to generating a markup language document using the same syntax for both content statements and logic statements. In one embodiment, a computer system is provided. The computer system has a processor and a computer readable storage device with instructions that are executable by the processor and that instantiate a user interface that allows a user to provide input including providing a first content statement in a markup language using a specified syntax and providing a first logic statement in the same markup language using the same specified syntax. The computer system also includes a markup language processing engine configured to interpret the first content statement and the first logic statement, and execute the first logic statement within the context of the first content statement.

In another embodiment, a method is provided for generating a markup language document using the same syntax for both content statements and logic statements. The method includes receiving input defining a content statement in a markup language using a specified syntax, and receiving input defining a logic statement in the same markup language using the same specified syntax. The method next includes interpreting the content statement and the logic statement using a markup language processing engine, where the interpreting includes identifying logic statements and executing the identified logic statements. The method further includes generating a markup language document using the interpreted content statement and the logic statement.

In another embodiment, a method is provided that includes providing interview questions that are part of an interview conducted with a user, receiving, from the user, answers to the interview questions and identifying content related to the received answers using a markup language processing engine. The markup language processing engine is configured to identify and execute logic statements from syntax that includes both content statements and logic statements. The content is identified using XQuery Markup Language (XQML) tags. The method also includes generating a markup language document based the identified content related to the received answers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including generating a markup language document using the same syntax for both content statements and logic statements.

FIG. 2 illustrates an example of homoiconic syntax.

FIG. 3 illustrates an embodiment in which a user implements a user interface to query a database regarding usage of a particular function in a markup language document.

FIG. 4 illustrates an embodiment of a database with an embedded XML engine.

FIG. 5 illustrates a flowchart of an example method for generate a markup language document using the same syntax for both content statements and logic statements.

FIG. 6 illustrates a flowchart of an alternative example method for generate a markup language document using the same syntax for both content statements and logic statements.

### DETAILED DESCRIPTION

Embodiments described herein are directed to a markup language that allows content and logic statements to be used in the same syntax. Embodiments are further directed to generating a markup language document using the same syntax for both content statements and logic statements. In one embodiment, a computer system is provided. The computer system has a processor and a computer readable storage device with instructions that are executable by the processor and that instantiate a user interface that allows a user to provide input including providing a first content statement in a markup language using a specified syntax and providing a first logic statement in the same markup language using the same specified syntax. The computer system also includes a markup language processing engine configured to interpret the first content statement and the first logic statement, and execute the first logic statement within the context of the first content statement.

In another embodiment, a method is provided for generating a markup language document using the same syntax for both content statements and logic statements. The method includes receiving input defining a content statement in a markup language using a specified syntax, and receiving input defining a logic statement in the same markup language using the same specified syntax. The method next includes interpreting the content statement and the logic statement using a markup language processing engine, where the interpreting includes identifying logic statements and executing the identified logic statements. The method further includes generating a markup language document using the interpreted content statement and the logic statement.

In another embodiment, a method is provided that includes providing interview questions that are part of an interview conducted with a user, receiving, from the user, answers to the interview questions and identifying content related to the received answers using a markup language processing engine. The markup language processing engine is configured to identify and execute logic statements from syntax that includes both content statements and logic statements. The content is identified using XQuery Markup Language (XQML) tags. The method also includes generating a markup language document based the identified content related to the received answers.

Embodiments described herein may implement various types of computing systems. These computing systems are now increasingly taking a wide variety of forms. Computing systems may, for example, be mobile phones, electronic appliances, laptop computers, tablet computers, wearable devices, desktop computers, mainframes, and the like. As used herein, the term “computing system” includes any device, system, or combination thereof that includes at least one processor, and a physical and tangible computer-readable memory capable of having thereon computer-executable instructions that are executable by the processor. A computing system may be distributed over a network environment and may include multiple constituent computing systems.

A computing system typically includes at least one processing unit and memory. The memory may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, methods, or similar computer-executable instructions that may be executed on the computing system. The different components, modules, engines, and services described herein may be implemented as objects or processes that execute on the computing system (e.g., as separate threads).

As described herein, a computing system may also contain communication channels that allow the computing system to communicate with other message processors over a wired or wireless network. Such communication channels may include hardware-based receivers, transmitters or transceivers, which are configured to receive data, transmit data or perform both.

Embodiments described herein also include physical computer-readable media for carrying or storing computer-executable instructions and/or data structures. Such computer-readable media can be any available physical media that can be accessed by a general-purpose or special-purpose computing system.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computing system to implement the disclosed functionality of the embodiments described herein. The data structures may include primitive types (e.g. character, double, floating-point), composite types (e.g. array, record, union, etc.), abstract data types (e.g. container, list, set, stack, tree, etc.), hashes, graphs or other any other types of data structures.

As used herein, computer-executable instructions comprise instructions and data which, when executed at one or more processors, cause a general-purpose computing system, special-purpose computing system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The embodiments herein may also be practiced in distributed system environments where local and remote computing systems, which are linked (either by hardwired data links, wireless data links, or by a combination of hardwired and wireless data links) through a network, both perform tasks. As such, in a distributed system environment, a computing system may include a plurality of constituent computing systems. In a distributed system environment, program modules may be located in both local and remote memory storage devices.

Those skilled in the art will also appreciate that the embodiments herein may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

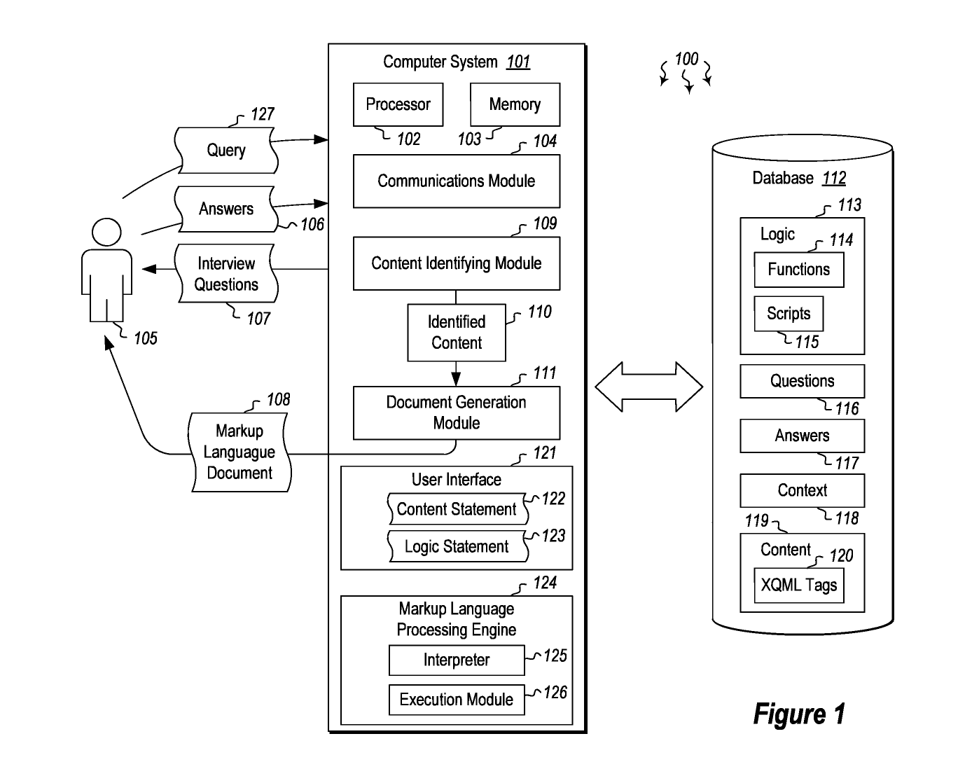

Referring to the figures, FIG. 1 illustrates a computer architecture 100 in which at least one embodiment described herein may be employed. The computer architecture 100 includes a computer system 101. The computer system 101 may be any type of local or distributed computer system, including a cloud computer system. The computer system 101 includes a hardware processor 102 and memory 103. The computer system 101 further includes modules for performing a variety of different functions.

For instance, the computer system 101 includes a communications module 104 may be configured to communicate with other computer systems. The communications module 104 may include any wired or wireless communication means that can receive and/or transmit data to or from other computing systems. The communications module 104 may be configured to interact with databases, mobile computing devices (such as mobile phones or tablets), embedded or other types of computing systems. The communications module 104 may, for example, be configured to communicate with database 112. The database 112 may be a local database, or a distributed (i.e. cloud) database. The database 112 may include different types of data, data items and/or data structures.

For instance, database 112 may be configured to store logic 113. This logic is data, and is stored as data. In the embodiments herein, the logic 113 may be referred to as data, as it is stored in the same manner as traditional data. The logic may include functions 114, scripts 115 or other types of logic that may be used within a markup language document. The database 112 may store many different types of markup language documents. These documents may be XML documents, hypertext markup language (HTML) documents, XHTML documents or other types of markup language documents. The term “documents”, as used herein, may refer to any portion or portions of markup language text, and does not necessarily need to be an individual markup language, word processing document or other type of document. In some cases, the markup language document may be a question or an answer or a series of questions and answers.

Embodiments herein may be implemented to create markup language documents (e.g. 108) or portions thereof. In one example, a user 105 may wish to create a document such as a legal or other type of document. The user 105 may be presented with questions 107 that are pertinent to their legal situation (e.g. marital status, number of children, type of business owned, bankruptcy status, homeowner status, etc.). When the user 105 provides their answers 106 to these questions, the answers may be stored in the database 112. The stored answers 117 may then be used, in conjunction with templates and other context information 118, to create markup language documents.

As mentioned above, the markup language used provides instructions for processing engines to interpret the markup language document. For example, a markup language processing engine may be configured to process markup language documents that include markup language syntax. In the embodiments herein, content statements and logic statements may both be represented in a single syntax. This is referred to herein as a “homoiconic” syntax. Traditionally, when a user wanted to call in functionality to an XML document, the XML document would have a link to a script or other programming function that was external to the XML document. In those cases, the syntax for the functional language (i.e. the logic) would be different than the syntax for content. Thus, an XML document creator would need to draft their XML document logic using one type of syntax, and draft their document content using another type of syntax. This is not the case when using a homoiconic syntax.

The homoiconic syntax derives its name from its functionality: namely, that it is a single symbol, single syntax functional markup language. The computer system 101 (or user 105 via user interface 121) may provide content statements 122 (e.g. an indication of a text element, a picture element, a video element or other content indicator) with the homoiconic syntax, and may further provide logic statements 123 (e.g. if, else, elseif, for, while or other logic control statements) with the same homoiconic syntax. The markup language processing engine 124 may be configured to interpret this homoiconic syntax and use it to perform functions such as creating markup language documents. In this manner, a markup language may be provided that allows users to construct documents using content statements and logic statements using the same homoiconic syntax.

An example of a portion of a document that includes of homoiconic syntax is shown below. The XML syntax includes multiple different logic statements including if, then and else statements.

### Example Syntax:

<?xml version=“1.0” encoding=“UTF-8” ?>

- <preview name=“BusinessDocx_Equity Interest_Stock Purchase
Agreement” id=“3602881471” product=“bdx” component-
source=“businessdocx_equity interest_stock purchase agreement”
pac=“bdx|businessdocx_equity interest_stock purchase agreement”
theme=“BDStyles4” branch=“master”>

<div style=“width:8.5in;padding-top:1in;padding-right:0.94in;padding-
bottom:1in;padding-left:1.06in”>
- <p pid=“_2614488708206540094” class=“Title”>

<getProperty name=“Equity Interest Term Singular_ESPA”
id=“530523177” format-source=“LIKE THIS” format=“LIKE
THIS” /> PURCHASE AGREEMENT

</p>

- <p pid=“_565783635109126614” class=“TextHeading2”> This
<getProperty name=“Equity Interest Term Singular_ESPA” id=“530523177”
/> Purchase Agreement (
<span style=“font-style:italic”>Agreement</span> ) between
- <if>
- <expr>
- <eq>

<getProperty name=“Seller Owner Type_ESPA” id=“418310657” />
<string>Entity</string>

</eq>
</expr>

- <then>
<getProperty name=“Seller Owner Name_ESPA” id=“1377944442”
/>,

- <if>
- <expr>
- <eq>

<getProperty name=“Seller Owner Entity Formation State_ESPA”
id=“3438883692” />
<string>Utah</string>

</eq>
</expr>
<then>a</then>
- <else>
<an />
</else>

</if>

Note that in the example homoiconic syntax above that multiple logic tags (e.g. <if>, <then>, <else>, etc.) are intermixed with content tags such as <p> and <string>. In one embodiment, the content identifying module 109 of computer system 101 may be used to identify content 119 (such as text, functions, scripts, pictures, video or other data) stored in database 112. Alternatively, the database 112 may includes its own embedded markup language engine that identifies the content statements, as well as the logic statements. In some cases, the content may be related to answers 106 provided by user 105. The content identifying module 109 may use context information 118 that is associated with the answers 117. Once the appropriate content has been identified, that identified content 110 can be accessed by the document generation module 111 to generate the markup language document 108. This markup language document 108 may then be sent to (or displayed for) user 105. The user can then interact with the document as needed.

XQuery Markup Language (XQML) is an example of a homoiconic markup language. The homoiconic markup language is a single symbol, single syntax markup language. Within this language, logic statements (e.g. functions 114 or scripts 115) are data. This allows queries to be performed on the logic statements. The queries may be designed to determine which variables are used in certain documents, or may be designed to determine where a given variable is used within the logic statements 113. In cases where the markup language used to construct the markup language document 108 is XQML, the markup language processing engine 124 used to interpret the XQML is an XML processing engine. The XML processing engine may be configured to search through nodes of the generated markup language document 108 to find operative tags. These tags may be interpreted by the interpreter 124 and then executed by the execution module 126 of the markup language processing engine 124.

Upon finding at least one operative tag, the markup language processing engine 124 may call out to a specified function (e.g. a stored function 114) according to the operative tag. The function itself 114 may be written in XQML. As noted, XQML is both a format language and an execution language. This allows for the presence of both content statements and logic statements in the same document in the same syntax. XML, on the other hand, is simply a format language, and not an execution language. It allows content statements, along with processing instructions which call out to external scripts or functions.

In the embodiments described herein, the functions 114 stored in the database 112 may not only be stored in and accessed from database 112, the functions 114 may also be run in the database. The markup language processing engine 124 may interpret the content and logic statements and determine that one or more functions 114 are to be run on the database 112. As such, these function will be executed in the database. In some cases, each customer or “tenant” may have their own segregated portion of that database on which their own templates, logic, questions, answers, UI or other data may be stored. In this manner, functions such as XQML functions may be stored in and run in a user's own segregated portion of the database 112.

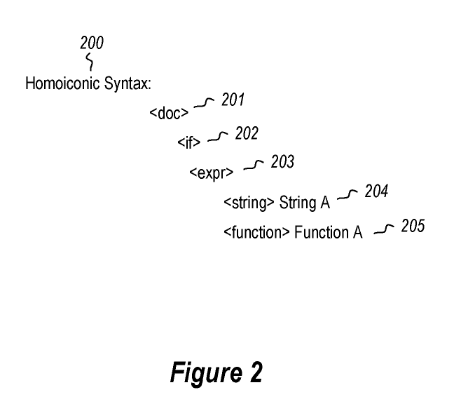

The functions 114 and/or scripts 115 may have arguments associated with them. The arguments for the specified function may be embedded in operative tags within the markup language document. For example, looking at operative function tag 205 of FIG. 2, the function tag may have a name (e.g. “Function A”) and any arguments associated with that name and tag. The operative tags may thus be combined with non-operative (i.e. structural) tags in order to formulate or define a document. In some cases, the logic statements 107 and content statements 106 are written in XQML. These statements may be interpreted by the markup language processing engine 124 to generate a document. Each content statement 122 may have a content source. That content source can be drawn from repeatedly for use in different documents. Thus, a single content statement 122 or logic statement 123 may be reused many times in many different documents.

Thus, in this manner, content and logic may be expressed together in the same syntax, as opposed to using separate syntaxes for content and logic. Logic statements may be directly incorporated in the syntax (e.g. XQML). As shown in FIG. 2, strings and functions (such as those stored in database 112) may be part of or embedded in homoiconic syntax 200. The homoiconic syntax 200 may include multiple different tags (in addition to those shown) and, as such, the tags show in FIG. 2 are not intended to be limiting, but are examples of what may be included in homoiconic syntax.

The syntax 200 of FIG. 2 may include a document tag 201 (<doc>), an if tag 202 (<if>), an expression tag 203 (<expr>), a string tag 204 (<string>) and a function tag 205 (<function>). The homoiconic syntax 200 thus allows for content tags (such as the document tag 201 or the string tag 204) and logic tags (such as the if tag 202 or the function tag 205) within the same syntax. The markup language processing engine 124 is configured to interpret both the content statements and the logic statements written in the same syntax. The markup language processing engine 124 thus processes the syntax in order to perform a function such as creating a markup language document (e.g. 108).

The markup language processing engine 124 knows how to process the content of each node. As such, it can traverse a markup language document, processing each node. In cases where the node is operative, instructions can be read by the processing engine and may call out to a script or function. In such embodiments, use of processing instructions or schemas may be avoided, thereby increasing computational efficiency. For instance, the generated markup language document 108 may be a form generated from a template. The form may be based on interview questions 107 and answers 106 provided by the user 105. In some cases, the form may be an XML form. The form is dynamically built by the document generating module 111. The answers may be tagged using XQML tags 120 that link the answers to content 119. In this manner, the XQML tags provide context 118 about the content, and allow that content to be found and inserted into the XML form. That content may also be reused in different forms.

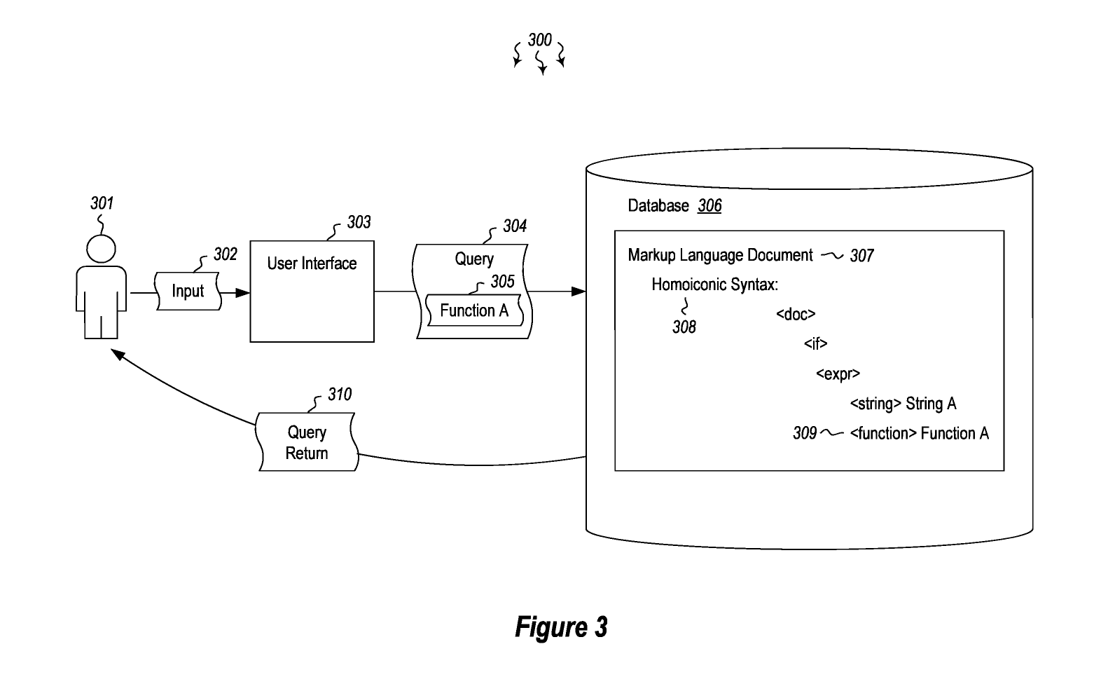

In some cases, in order to find other related content, the markup language processing engine may further perform a query across one or more interviews and/or related files (e.g. component files) to determine where a specified element appears. The processing engine may thus determine where given variables appear (e.g. in which expressions the variables appear). For instance, as shown in FIG. 3, a user 301 may provide input 302 via user interface 303. The input 302 may specify a query 304 to determine where Function A (305) occurs within one or more markup language documents (e.g. 307). The query 304 is sent to the database 306 and carried out against document 307.

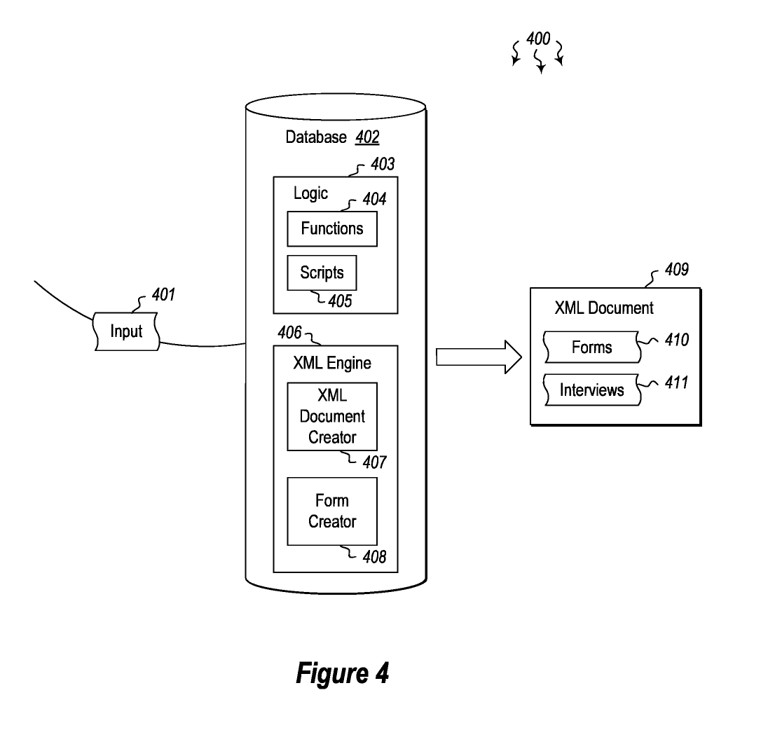

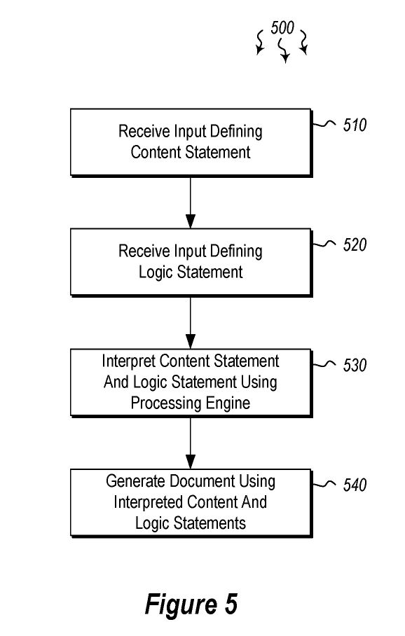

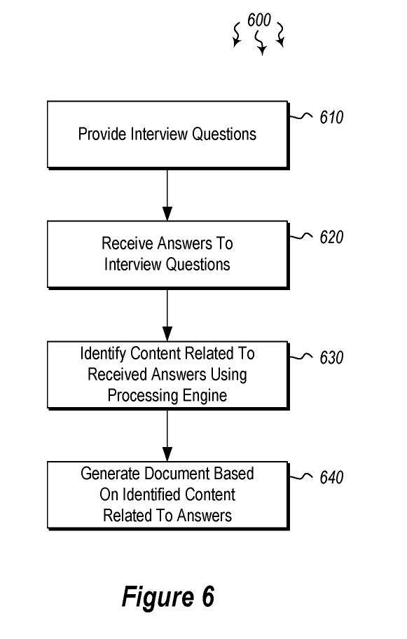

In some cases, the query may be handled by an embedded XML engine. For example, FIG. 4 illustrates an embodiment in which XML engine 406 is embedded within database 402. The XML engine includes an XML document creator 407, a form creator 408 and other functionality. The XML engine 409 may use these components to generate XML document 409, which itself has various forms 410 and/or interview questions or answers 411. Once the embedded XML engine 409 searches through the document 307 for Function A (305), it may determine that that function appears at <function> tag 309, among other places. The results of the query 310 may be returned to the user 301 via the user interface 303 which may display the results to the user. These and other embodiments will be described further below with regard to methods 500 and 600 of FIGS. 5 and 6, respectively.

In view of the systems and architectures described above, methodologies that may be implemented in accordance with the disclosed subject matter will be better appreciated with reference to the flow chart of FIGS. 5 and 6. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 5 illustrates a flowchart of a method 500 for generating a markup language document using the same syntax for both content statements and logic statements. The method 200 will now be described with frequent reference to the components and data of environment 100 of FIG. 1.

The method 500 may be implemented by a computer system such as computer system 101 of FIG. 1. The computer system may include one or more processors 102, and a computer-readable storage device that stores computer-executable instructions which, when executed, instantiate a user interface 121 that allows a user 105 to provide user input including the following: providing a first content statement 122 in a markup language using a specified syntax, and a first logic statement 123 in the same markup language using the same specified syntax. The computer system 101 also includes a markup language processing engine 124 configured to interpret the first content statement 122 and the first logic statement 123, as well as execute the first logic statement within the context of the first content statement.

The markup language processing engine 124 includes an interpreter 125 that allows the engine to analyze and determine which markup language statements are content statements and which are logic statements. Then, using the execution module 126, the markup language processing engine 124 executes the logic statements without having to call an external script or function. Rather, the logic statements can be handled in line with the content statements, as provided in a homoiconic markup language. Indeed, providing both the first content statement 122 and the first logic statement 123 in the same syntax is facilitated through a homoiconic markup language such as XQML. The homoiconic markup language is a single symbol, single syntax markup language that allows content and logic statements to be provided together using the same type of syntax. The avoids the problems associated with previous solutions that implemented one type of syntax for content and another type of syntax for logic (e.g. scripting or execution languages such as PERL, JavaScript, C++, etc.).

The logic statements themselves comprise data and are stored as data in database 112. Because the logic statements are stored as data, queries may be performed against the data of the logic statement. As shown in FIG. 3, a user 301 may use user interface 303 to input a query 304 for a certain function (Function A 305). Occurrences of Function A can then be searched for throughout the markup language document 307. The term “Function A” may occur in logic statements, in content statements or elsewhere. Each occurrence will be part of the main markup language document—no external scripts or functions will need to be searched, thereby saving processing resources, as well as database and/or network bandwidth resources that might have been used to access the external scripts or functions.

In some cases, the markup language processing engine 124 comprises an extensible markup language (XML) processing engine. As shown in database 402 of FIG. 4, an XML processing engine 406 may be provided as part of the database's functionality. The XML processing engine 406 may be configured to process queries (e.g. input 401), process logic 403, functions 404, scripts 405 or other input data in order to carry out queries and/or generate XML documents.

For instance, in the case of a query coming from a user or other computer system, the XML engine may search for properties or variables used in logic statements in a markup language document to identify where in the document those properties or variables are used. As mentioned above, these properties and variables may appear in content statements, in logic statements or in other portions of the document. This may allow a developer or other user to easily see where certain functions are used, or where variables appear in the logic and content of a markup language document. This may aid the developer in identifying why certain functionality isn't working (i.e. debugging), or may aid the developer in optimizing their logic and/or content statements.

The XML processing engine 406 may be configured to search through tags, words, phrases or other nodes of an XML document to find operative tags. These operative tags may be logic tags such as <if>, <else>, etc. Upon finding at least one operative tag, the XML processing engine 406 may call out to a specified function according to the operative tag. That specified function may be written in XQML, a homoiconic markup language. The function is stored as data, and may be queried in the same manner as the XML document 409.

The method 500 of FIG. 5 first includes receiving input defining at least one content statement in a markup language using a specified syntax (510). For example, as shown in FIG. 1, user 105 may provide input via user interface 121 defining content statement 122. The content statement may define images, text, videos or other content that are to be part of an XML document. Method 500 further includes receiving input defining at least one logic statement in the same markup language using the same specified syntax (520). Using user interface 121, the user 105 may also provide a logic statement 123 using the same markup language syntax. The logic statement may provide logical steps that are to be taken within the document (such as if X, then do Y). Traditionally, processing instructions may allow engines to call scripts or functions that are external to the document, but they do not allow logic statements within the markup language document using the same syntax as the content statements.

Method 500 next includes interpreting the at least one content statement and the at least one logic statement using a markup language processing engine, the interpreting including identifying logic statements and executing the identified logic statements (530). For example, the interpreter 125 of the markup language processing engine 124 may interpret the content and logic statements (122 and 123). This interpreting involves identifying logic statements 123 and then executing those logic statements according to the operation indicated by the logic statement. The markup language processing engine 124 then generates a markup language document 108 using the interpreted content statement 122 and the logic statement 123 (540).

When interpreting the content and logic statements, the markup processing engine 124 may call out to a specified function according to an operative tag such as an expression or <expr> tag 203, a <string> tag 204 or a <function> tag 205, as shown in FIG. 2. Other operative tags may be used in addition to or as an alternative to those shown in FIG. 2. The specified function that is called out may be written in XQML or in another homoiconic markup language. The specified function may be both stored and run in a database. For instance, the (XQML) functions 114 may be stored in database 112, as well as executed within database 112. As indicated in FIG. 4, XML engine (or some other type of markup language processing engine) may be embedded in database 402. This embedded markup language processing engine may process the functions stored in that database.

Each function may have arguments or values associated therewith. The arguments or values associated with the specified function may be embedded in the function's operative tag. This inclusion of arguments or values in the operative tags may reduce storage space and may prevent having to dedicate processor or storage access time to accessing the arguments or values in a different location. In cases where multiple markup language documents are to be generated, storage resources may further be reduced by storing a single content source and reusing that content source in multiple markup language documents. Thus, if a group of documents (e.g. legal documents) share certain pieces of content, that content can be reused in each of the documents. The content 119 may be stored in the database 112, along with any corresponding operational XQML tags 120.

Documents generated by the markup language processing engine 124 (e.g. 108) may correspond to the type of engine processing them. For instance, if the markup language processing engine 124 is an XML engine, the generated markup language document 108 will be an XML document. In some cases, these XML documents may be forms or may include forms as part of the document. Generating the XML document may include dynamically building forms. For instance, as shown in FIG. 4, the XML document 409 may include 410. These forms may be reusable content, and may include questions 116 and/or answers 117 to interview questions. The answers to these interview questions may determine which portions of content are added to the XML document. The forms may be dynamically built based on input provided by a user.

For instance, if the XML engine 406 is generating a legal document, the document may include certain types of legal forms that apply based on answers to questions. Indeed, some legal forms may not apply to people above or below a certain age, or may apply to women and not to men, or may apply to people interested in creating a will. Thus, based on the user's answers to certain interview questions, different forms may apply. These forms may be reused in many different markup language documents. And, like the logic and other content, the forms may be stored in the same database on which they are integrated into documents by the markup language processing engine. This process, including document generation in the context of an interview, will be explained further below with regard to method 600 of FIG. 6.

FIG. 6 illustrates a flowchart of a method 600 for generating a markup language document using the same syntax for both content statements and logic statements. The method 600 will now be described with frequent reference to the components and data of environment 100 of FIG. 1.

Method 600 includes providing one or more interview questions that are part of an interview conducted with a user (610). For example, the interview questions 107 may be provided on user interface 121. The user interface may display the interview questions 107 to user 105. The computer system 101 may then receive, via the user interface 121, one or more answers 106 to the interview questions (620). These interview questions may be related to substantially any topic, and may include questions about the user or about the user's interests or about other topics. As the user answers the questions, the content identifying module 109 may identify content related to the answers 106 received from the user 105.

Indeed, method 600 includes identifying content related to the received answers using a markup language processing engine, where the markup language processing engine is configured to identify and execute logic statements from syntax that includes both content statements and logic statements, and where the content is identified using XQuery Markup Language (XQML) tags (630). Then, the document generation module 111 generates a markup language document 108 based the identified content 110 related to the received answers (640). Thus, as the user provides answers to questions, the computer system may identify content that is relevant to those answers (such as portions of a legal document that apply to the user based on the user's answers) and provide those portions of content in the markup language document 108.

In some embodiment, the computer system 101 is a server computer system, and the interview questions 116, answers 117, XQML tags 120, and/or corresponding user content 119 are stored on and executed on the server computer system. In such embodiments, anything driving the interview is coming from a single source. Still further, anything relating to a given user may come from a sequestered part of the server computer system, that is only accessible by that user or certain specified users with proper permissions. Any executable code associated with the markup language document 108 is run on the server computer system 101. As such, instead of calling scripts which run on the client side (as is the case with traditional XML documents), all processing may be done server-side. This improves computing performance and provides for a more efficient and seamless user experience.

Server-side execution is made possible by using a homoiconic markup language such as XQML. As mentioned above, XQML is an execution language (whereas XML is only a markup language—not an execution language). The homoiconic markup language described herein combines features of both into one syntax. This allows for more efficient execution within the computer system, and also allows searches to be performed on the logic 113 of the markup language document. Logic tags may be embedded in the markup language document. Any arguments that are associated with the operative logic tag may be embedded in the tag itself.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computer system comprising the following:
one or more processors;
at least one computer-readable storage device that stores computer-executable instructions which, when executed, instantiate a user interface that allows a user to provide user input including the following:
providing a first content statement in a markup language using a specified syntax; and
providing a first logic statement in the same markup language using the same specified syntax; and
a markup language processing engine configured to perform the following:
interpreting the first content statement and the first logic statement; and
executing the first logic statement within the context of the first content statement.

2. The computer system of claim 1, wherein providing both the first content statement and the first logic statement in the same syntax is facilitated through a homoiconic markup language, wherein the homoiconic markup language is a single symbol, single syntax markup language.

3. The computer system of claim 1, wherein the first logic statement comprises data, allowing queries to be performed on the data of the logic statement.

4. The computer system of claim 1, wherein the markup language processing engine comprises an extensible markup language (XML) processing engine.

5. The computer system of claim 4, further comprising searching, using the XML processing engine, for properties or variables used in one or more logic statements in a document to identify where in the document those properties or variables are used.

6. The computer system of claim 5, wherein the XML processing engine searches through nodes of an XML document to find operative tags.

7. The computer system of claim 6, wherein upon finding at least one operative tag, the XML processing engine calls out to a specified function according to the operative tag.

8. The computer system of claim 7, wherein the specified function is written in XQML.

9. A method, implemented at a computer system that includes at least one processor, for generating a markup language document using the same syntax for both content statements and logic statements, the method comprising:
receiving input defining at least one content statement in a markup language using a specified syntax;
receiving input defining at least one logic statement in the same markup language using the same specified syntax;
interpreting the at least one content statement and the at least one logic statement using a markup language processing engine, the interpreting including identifying logic statements and executing the identified logic statements; and
generating a markup language document using the at least one interpreted content statement and the at least one logic statement.

10. The method of claim 9, wherein the markup processing engine calls out to a specified function according to an operative tag, the specified function being written in XQML.

11. The method of claim 10, wherein the specified function is stored and run in a database.

12. The method of claim 10, wherein arguments for the specified function are embedded in the operative tag.

13. The method of claim 11, further comprising storing a single content source and reusing the content source in multiple markup language documents.

14. The method of claim 1, wherein the generated markup language document comprises an XML document, and wherein generating the XML document comprises dynamically building one or more forms.

15. The method of claim 14, wherein the forms are dynamically built based on input provided by a user.

16. The method of claim 14, wherein the XML document is generated using an XML engine, the XML engine being embedded in a database.

17. A method, implemented at a computer system that includes at least one processor, for generating a markup language document using the same syntax for both content statements and logic statements, the method comprising:
providing one or more interview questions that are part of an interview conducted with a user;
receiving, from the user, one or more answers to the interview questions;
identifying content related to the received answers using a markup language processing engine, the markup language processing engine being configured to identify and execute logic statements from syntax that includes both content statements and logic statements, the content being identified using XQuery Markup Language (XQML) tags; and
generating a markup language document based on the identified content related to the received answers.

18. The method of claim 17, wherein the computer system comprises a server computer system, and wherein the interview questions, the XQML tags, and corresponding user content are stored on and executed on the server computer system.

19. The method of claim 17, wherein the XQuery Markup Language is an execution language.

20. The method of claim 17, wherein the XQML execution language allows content statements and logic statements to be searched within the generated markup language document.
